(19) United States
(12) Patent Application Publication
(10) Pub. No.: US 2026/0369977 A1
(43) Pub. Date: Nov. 19, 2026

(54) ELECTRICAL CONNECTION BOX

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); TOYOTA JIDOSHA KABUSHIKI KAISHA, Toyota-shi, Aichi (JP)

(72) Inventors: Takayuki TAKEUCHI, Yokkaichi-shi (JP); Takumi EJIMA, Yokkaichi-shi (JP); Kensaku NAKAHIRA, Toyota-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); TOYOTA JIDOSHA KABUSHIKI KAISHA, Toyota-shi, Aichi (JP)

(21) Appl. No.: 19/677,314

(22) Filed: May 14, 2026

(30) Foreign Application Priority Data
May 14, 2025 (JP) 2025-080905

(51) Int. Cl. H02G 3/08

(52) U.S. Cl. CPC H02G 3/081

(57) ABSTRACT

An electrical connection box 10 includes a case 20 having a guide hole 21, a movable member 40 disposed inside the guide hole 21, and a biasing member disposed between the case 20 and the movable member 40. The case 20 is fixed to the mounting surface 91 by fastening the fixing member 80. The movable member 40 is movable in a moving direction toward the mounting surface 91 while resisting the biasing force of the biasing member during a fastening process of the fixing member 80. The distal end of the movable member 40 in the moving direction is in contact with the mounting surface 91 when the fixing member 80 is fastened.

### CROSS-REFERENCE TO RELATED APPLICATIONS

This application claims the benefit of Patent Application No. 2025-080905, filed in Japan on May 14, 2025, the content of which is incorporated herein by reference.

### BACKGROUND OF THE INVENTION

### 1. Field of the Invention

The present disclosure relates to an electrical connection box.

### 2. Description of Related Art

An electrical connection box described in JP 2024-100335 A includes a case referred to as a housing. The case includes an upper cover and a lower cover. Each of the upper cover and the lower cover has second fastening portions. A fixing member is fastened to each of the second fastening portions. The case is fixed to a mounting portion of a vehicle by the respective fixing members. The mounting portion has a plurality of fastening portions corresponding to the respective fixing members.

### SUMMARY OF THE INVENTION

In recent years, many cases are made of a synthetic resin containing glass fibers and tend to be less elastically deformable. For example, when a case contains glass fibers, if the fixing members are forcibly fastened in a state where the height positions of the respective fastening portions are displaced from predetermined positions due to tolerance variations or the like, there is a risk that the case may be damaged beyond its elastic limit.

Accordingly, an object of the present disclosure is to provide an electrical connection box capable of suppressing damage to a case during fastening of a fixing member.

An electrical connection box of the present disclosure includes a case having a guide hole, a movable member disposed inside the guide hole, and a biasing member disposed between the case and the movable member, wherein the case is fixed to a mounting surface by fastening a fixing member, wherein the movable member is movable in a moving direction toward the mounting surface while resisting a biasing force of the biasing member during a fastening process of the fixing member, and wherein a distal end of the movable member in the moving direction is in contact with the mounting surface when the fixing member is fastened.

According to the present disclosure, it is possible to provide an electrical connection box capable of suppressing damage to a case during fastening of a fixing member.

### BRIEF DESCRIPTION OF THE DRAWINGS

FIG. 1 is an enlarged cross-sectional view of a main part of a guide hole, and a movable member, a compression coil spring, and the like disposed inside the guide hole, before fastening a fixing member in an electrical connection box of a first embodiment;

FIG. 2 is an enlarged cross-sectional view of the main part of the guide hole, and the movable member, the compression coil spring, and the like disposed inside the guide hole, when the fixing member is fastened in the electrical connection box of the first embodiment;

FIG. 3 is an enlarged cross-sectional view of the main part of the guide hole different from that of FIG. 2, and the movable member, the compression coil spring, and the like disposed inside the guide hole, when the fixing member is fastened in the electrical connection box of the first embodiment;

FIG. 4 is a schematic plan view of a case fixed to a mounting surface when the fixing member is fastened in the electrical connection box according to the first embodiment.

FIG. 5 is an enlarged plan view of a main part of a guide peripheral wall portion of the case in the electrical connection box of the first embodiment.

FIG. 6 is an enlarged cross-sectional view of the main part of the guide peripheral wall portion of the case in the electrical connection box of the first embodiment.

FIG. 7 is a perspective view of the movable member in the electrical connection box of the first embodiment.

### DETAILED DESCRIPTION OF PREFERRED EMBODIMENTS

### Description of embodiments of the present disclosure

First, embodiments of the present disclosure will be listed and described.

(1) An electrical connection box of the present disclosure includes a case having a guide hole, a movable member disposed inside the guide hole, and a biasing member disposed between the case and the movable member, wherein the case is fixed to a mounting surface by fastening a fixing member, wherein the movable member is movable in a moving direction toward the mounting surface while resisting a biasing force of the biasing member during a fastening process of the fixing member, and wherein a distal end of the movable member in the moving direction is in contact with the mounting surface when the fixing member is fastened.

When the fixing member is fastened, the distal end of the movable member in the moving direction comes into contact with the mounting surface, and thus a state in which the case is fixed to the mounting surface can be reliably formed. For example, when the case has a plurality of guide holes and the movable member is disposed inside each guide hole, even if the height positions of the mounting surface corresponding to the respective fixing members are displaced from predetermined positions due to tolerance variations or the like, such positional deviation is absorbed by the biasing member disposed between the case and the movable member. As a result, it is possible to suppress damage to the case during fastening of the fixing member. In the present specification, the phrase “when the fixing member is fastened” refers to a state after fastening of the fixing member is completed.

(2) In the electrical connection box according to (1), the biasing member is preferably a compression coil spring. The compression coil spring can bias the movable member with an appropriate biasing force according to the magnitude of the movement stroke of the movable member.

(3) In the electrical connection box according to (2), it is preferable that the movable member includes a cylindrical portion extending in the moving direction and a flange portion projecting outward from the cylindrical portion in a radial direction thereof, a support portion is provided inside the guide hole at a position away from the flange portion in the moving direction, the support portion is provided integrally with the case or fixed to the case, the compression coil spring is compressibly disposed between the support portion and the flange portion, and a shaft portion of the fixing member is disposed inside the cylindrical portion. According to this configuration, the movable member and the compression coil spring can be disposed in the case together with the fixing member with high space efficiency.

(4) In the electrical connection box according to (3), it is preferable that the case includes an elastic lock portion along an inner surface of the guide hole, the elastic lock portion has a protrusion protruding into the guide hole, and the flange portion is disposed between the protrusion and the compression coil spring in the moving direction. According to this configuration, the movable member can be inserted into the guide hole after the elastic lock portion is elastically deformed. The movable member inserted into the guide hole is prevented from coming out of the guide hole by contacting the protrusion. Accordingly, the movable member can be prevented from coming out with a relatively simple structure.

Details of embodiments of the present disclosure Specific examples of embodiments of the present disclosure will be described below with reference to the drawings. The present invention is not limited to this example, but is indicated by the claims, and is intended to include all modifications within the meaning and scope equivalent to the claims.

### First embodiment

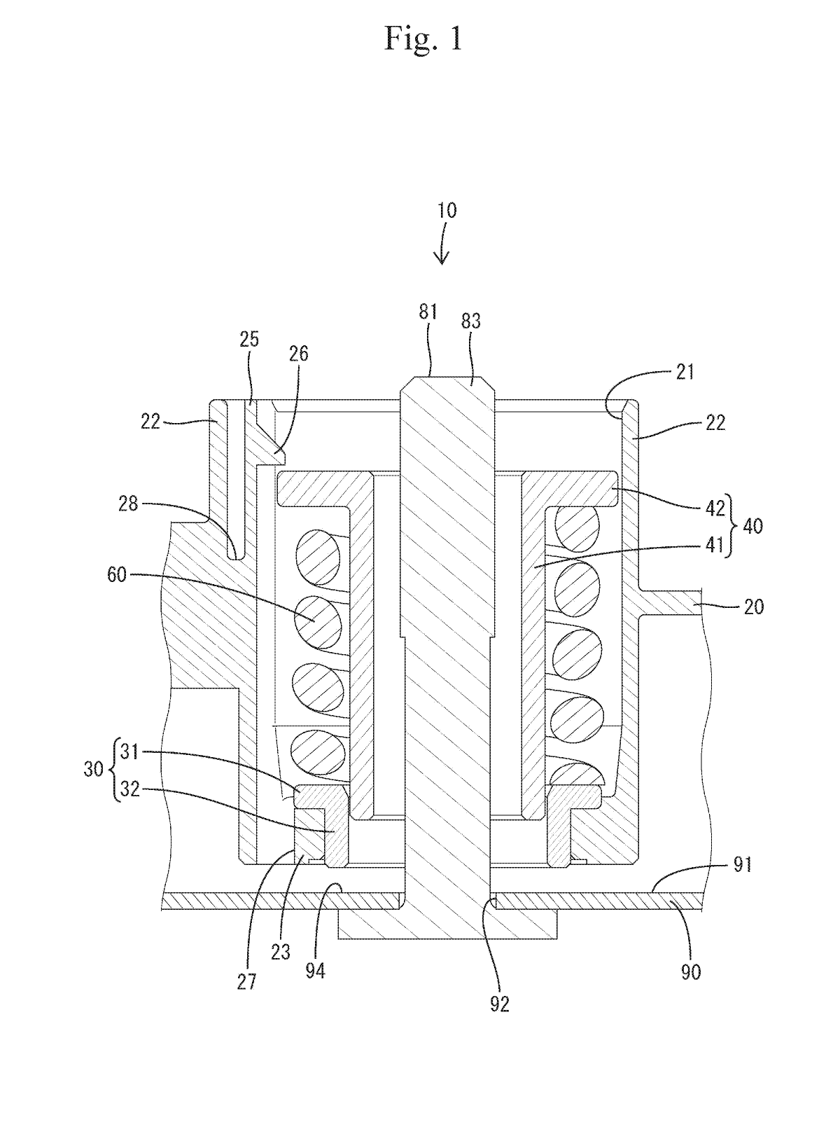

As illustrated in FIGS. 1-3, an electrical connection box 10 of a first embodiment of the present disclosure includes a case 20, a movable member 40, and a compression coil spring 60 as a biasing member. The electrical connection box 10 is attached to, for example, a battery pack of an electric vehicle. Although not illustrated, the battery pack includes a metal housing. The case 20 is fixed to a mounting surface 91 of a plate-shaped portion 90 of the housing by a fixing member 80. Here, the fixing member 80 includes a stud bolt 81 protruding from the mounting surface 91 and a nut 82 screwed onto the stud bolt 81. The stud bolt 81 has a shaft portion 83 which is inserted through a hole 92 formed in the plate-shaped portion 90 and protrudes therefrom. A thread is formed on the shaft portion 83. In the following description, for convenience, a vertical direction in FIGS. 1-3 is defined as a vertical direction. The vertical direction does not necessarily coincide with a vertical direction of a gravity direction, and is a direction set for convenience of description.

### Case 20

The case 20 is made of a synthetic resin. In the first embodiment, the case 20 is made of a synthetic resin containing glass fibers. Here, the case 20 is an upper case, covers a lower case (not illustrated), and forms a flat box-shaped case as a whole together with the lower case. Electronic components such as a fuse, a relay, and a bus bar are mounted in the case 20 (for convenience of drawing, illustration of the electronic components is omitted).

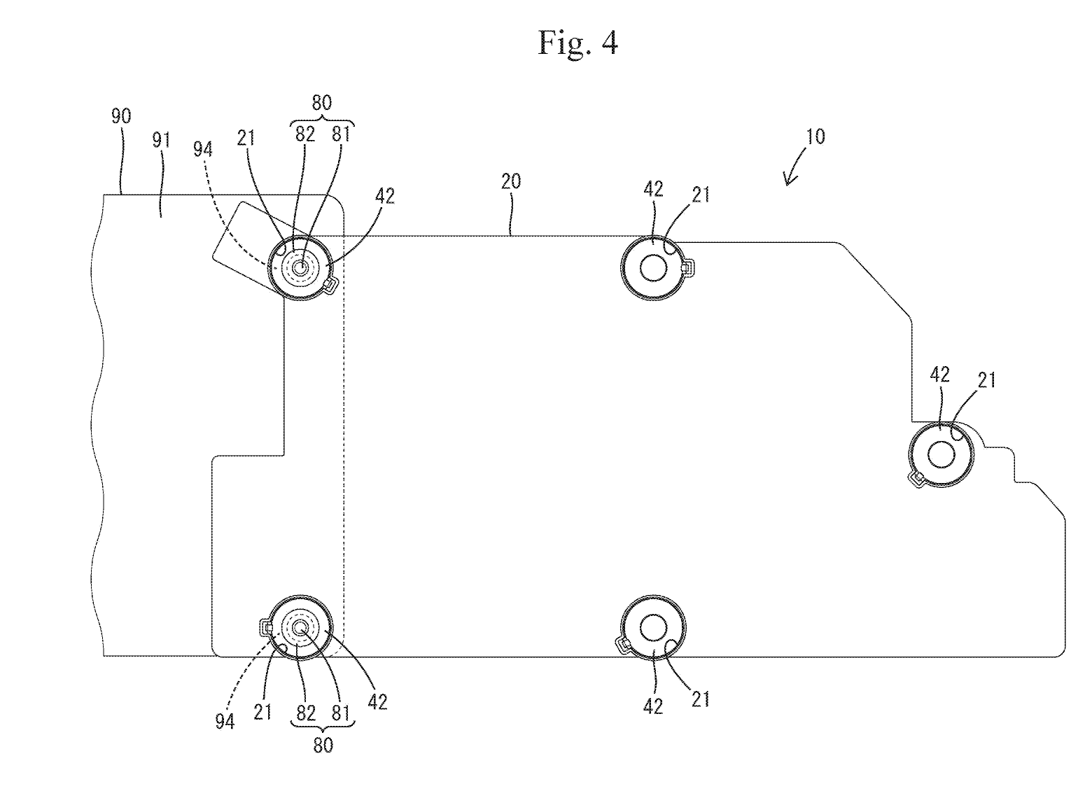

As illustrated in FIG. 4, the case 20 has a plurality of guide holes 21. The guide holes 21 are provided at a plurality of locations including corner portions of the case 20 in a plan view (five locations in the illustrated example) with spacing therebetween. The following description focuses on one guide hole 21 and its peripheral structure unless otherwise specified.

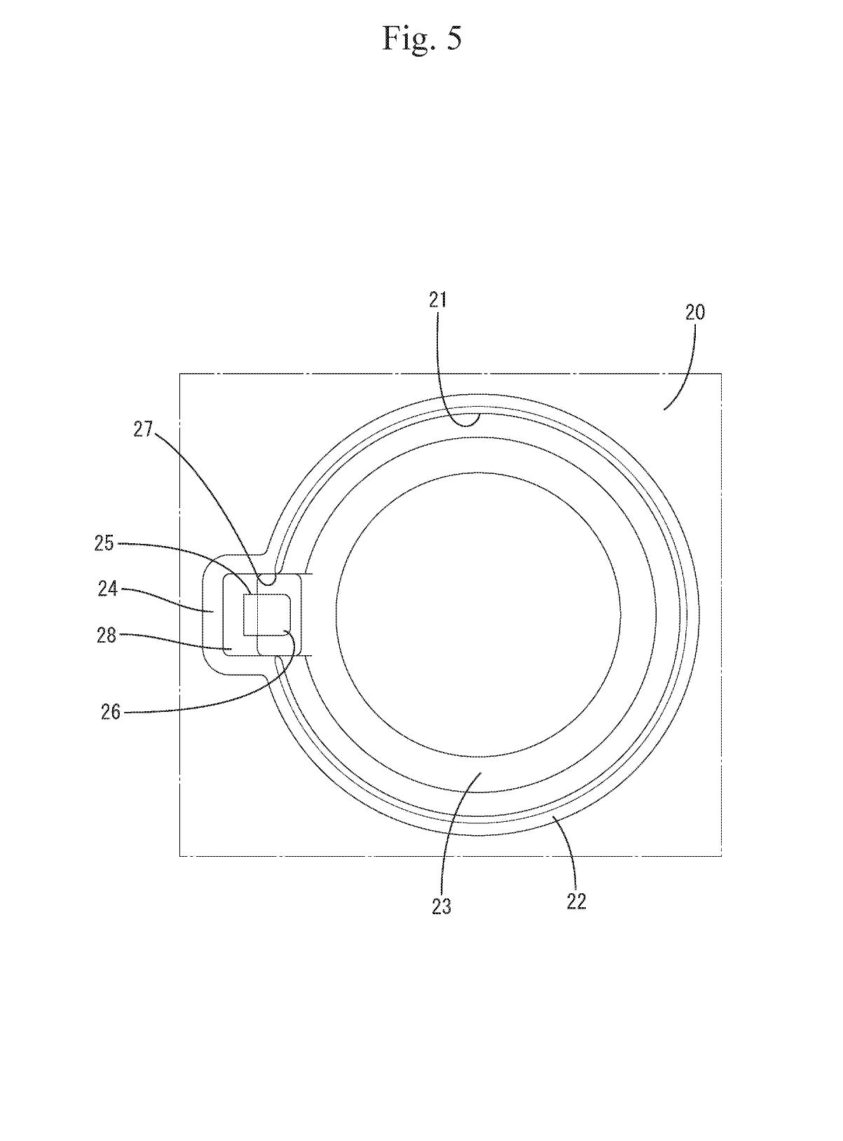

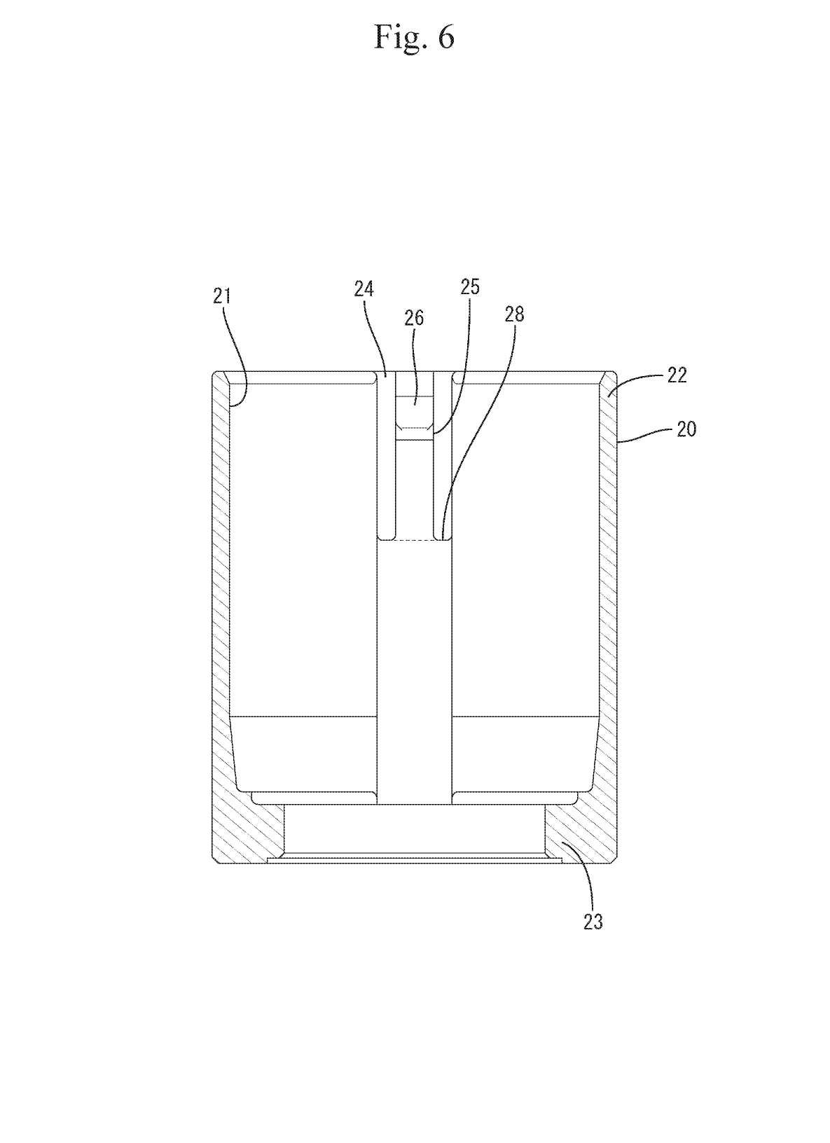

As illustrated in FIGS. 5 and 6, the guide hole 21 extends vertically through the case 20 and opens in a circular shape in plan view. The guide hole 21 is formed in a cylindrical guide peripheral wall portion 22 of the case 20. A lower end portion of the guide peripheral wall portion 22 is provided with a support receiving portion 23 projecting radially inward over the entire circumference. An opening at a lower surface of the guide hole 21 is narrowed by the support receiving portion 23.

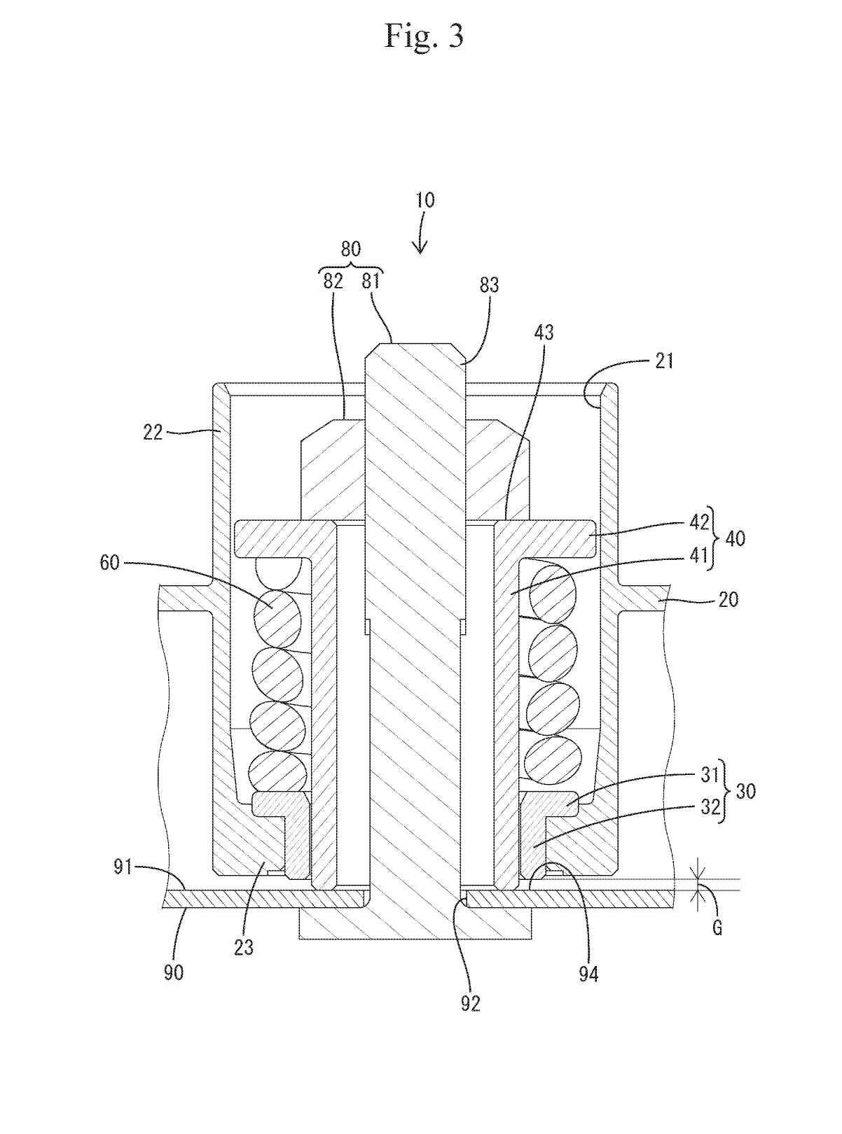

As illustrated in FIG. 3, a support portion 30 is provided at the lower end portion of the guide peripheral wall portion 22. Here, the support portion 30 is formed as a metal embedded collar separate from the case 20. The embedded collar as the support portion 30 is insert-molded and fixed to the support receiving portion 23. The support portion 30 includes an annular portion 31 having an annular shape and a cylindrical inner peripheral portion 32 protruding downward from a radially inner end of the annular portion 31. The annular portion 31 is disposed to face an upper surface of the support receiving portion 23. A lower end of the compression coil spring 60 is supported in contact with the annular portion 31, and is preferably integrally connected to the annular portion 31. The inner peripheral portion 32 is disposed to face an inner surface of the support receiving portion 23. A lower end of the inner peripheral portion 32 is positioned below a lower end of the support receiving portion 23.

As illustrated in FIGS. 5 and 6, the case 20 includes, at an upper portion of the guide peripheral wall portion 22, a bulging portion 24 having a shape bulging outward in the radial direction, and an elastic lock portion 25 provided inside the bulging portion 24 so as to be elastically deformable. The bulging portion 24 is disposed at a position where it can come into contact with the elastic lock portion 25 when the elastic lock portion 25 tends to elastically deform excessively outward in the radial direction, and can suppress excessive deflection of the elastic lock portion 25.

The elastic lock portion 25 is formed in the upper portion of the guide peripheral wall portion 22 so as to protrude upward in a cantilever manner from a bottom surface 28 of the bulging portion 24. A protrusion 26 is provided at an upper end portion of the elastic lock portion 25 so as to protrude radially inward. The protrusion 26 has a claw-like shape, and a distal end thereof is disposed inside the guide hole 21. As illustrated in FIG. 1, the compression coil spring 60 is disposed between the distal end of the protrusion 26 and the support portion 30 together with a flange portion 42 described later. In the guide peripheral wall portion 22, a mold release hole 27 is provided at a portion on which the protrusion 26 is projected vertically downward. The mold release hole 27 is formed due to withdrawal of a mold used to form the protrusion 26. The mold release hole 27 penetrates a root portion of the support receiving portion 23. An inner end of the annular portion 31 in a radial direction faces the mold release hole 27.

### Movable member 40

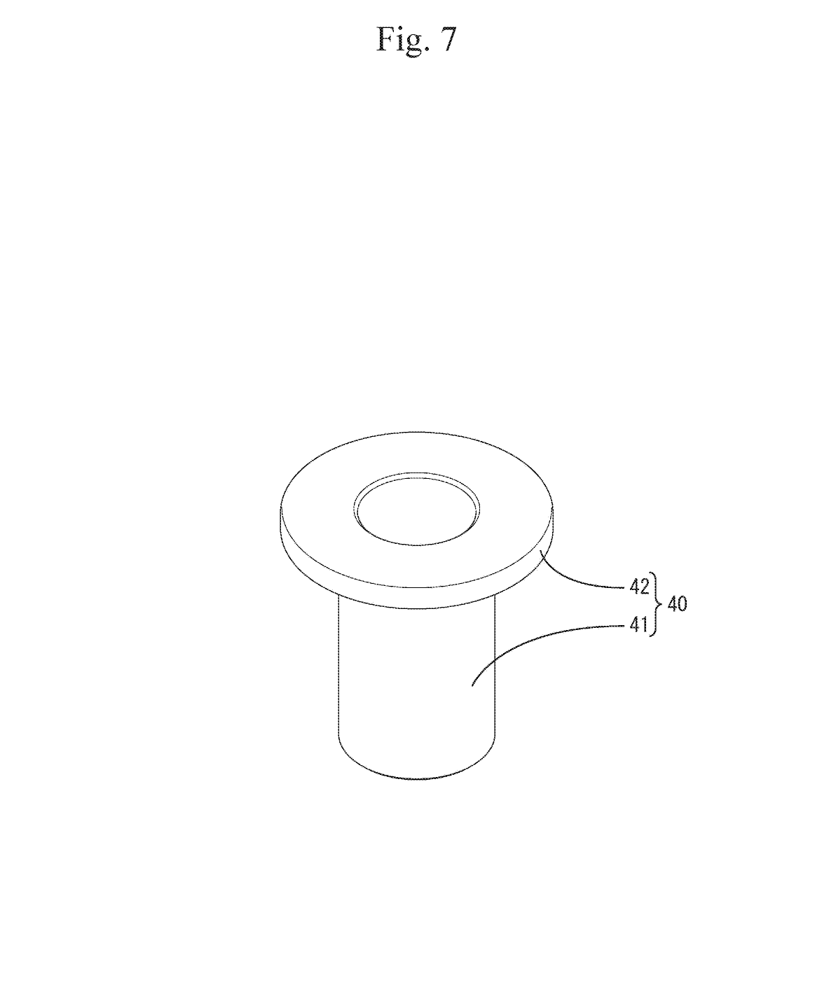

The movable member 40 is mounted to the case 20 so as to be movable inside the guide hole 21. As illustrated in FIG. 7, the movable member 40 is formed as, for example, a metal flanged collar separate from the case 20. The movable member 40 includes a cylindrical portion 41 having a cylindrical shape with an axis oriented in the vertical direction, and a flange portion 42 projecting outward in a radial direction from an upper end of the cylindrical portion 41 over the entire circumference.

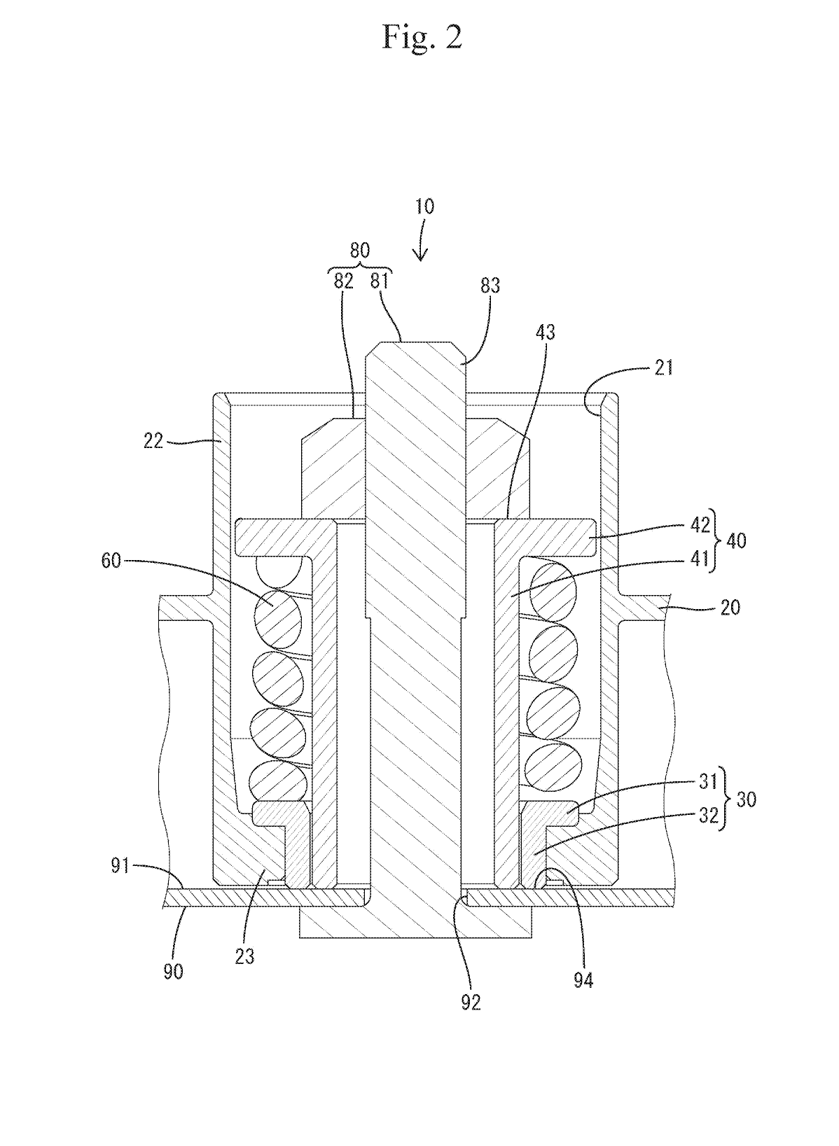

The cylindrical portion 41 is formed in a cylindrical shape. As illustrated in FIG. 1, the outer diameter of the cylindrical portion 41 is smaller than the inner diameter of the inner peripheral portion 32 of the support portion 30. The inner diameter of the cylindrical portion 41 is larger than the outer diameter of the shaft portion 83 of the stud bolt 81. The shaft portion 83 is inserted into the cylindrical portion 41. Here, the axis of the shaft portion 83 is disposed coaxially with the radial center of the cylindrical portion 41. The length (cylinder length) of the cylindrical portion 41 in the vertical direction is smaller than each of the length (shaft length) of the shaft portion 83 in the vertical direction and the length (hole length) of the guide hole 21 in the vertical direction, and is larger than a separation distance between the protrusion 26 and the support portion 30 in the vertical direction as illustrated in FIG. 1. Before fastening the fixing member 80, the upper end of the cylindrical portion 41 is disposed below the protrusion 26 and at a position overlapping the elastic lock portion 25 in the vertical direction. A lower end of the cylindrical portion 41 is disposed below the annular portion 31 and at a position overlapping the support portion 30 in the vertical direction. As shown in FIGS. 2 and 3, when the fixing member 80 is fastened, the lower end of the cylindrical portion 41 comes into contact with the fastening portion 94 of the mounting surface 91. The lower end of the inner peripheral portion 32 of the support portion 30 may also come into contact with the fastening portion 94 of the mounting surface 91. The cylindrical portion 41 moves along an inner surface of the inner peripheral portion 32 in the fastening process of the fixing member 80. The upper end of the cylindrical portion 41, together with an upper surface of the flange portion 42, constitutes a seating surface 43 that receives the nut 82.

In the first embodiment, the thickness of the flange portion 42 in the vertical direction is larger than the thickness of the cylindrical portion 41 in the radial direction. The outer diameter of the flange portion 42 is smaller than the hole diameter of the guide hole 21 and larger than the outer diameter of the compression coil spring 60. The radial width of the flange portion 42 is larger than the wire diameter of the compression coil spring 60. An upper end of the compression coil spring 60 is in contact with the lower surface of the flange portion 42. A vertical separation distance between the flange portion 42 and the support portion 30 changes in accordance with compression of the compression coil spring 60. As illustrated in FIG. 1, before fastening of the fixing member 80, when the compression coil spring 60 is not subjected to a force from the nut 82, a gap in the vertical direction is formed between a radially outer end of the flange portion 42 and the distal end of the protrusion 26.

### Compression coil spring 60

The compression coil spring 60 is made of, for example, a metal material such as a spring steel material, a hard steel material, or a piano wire. In the first embodiment, the compression coil spring 60 is accommodated in the guide hole 21 in a state where the axis of the compression coil spring is aligned with the axis of the shaft portion 83 of the stud bolt 81. The compression coil spring 60 presses the flange portion 42 while being supported by the support portion 30, thereby biasing the movable member 40 upward. Here, the compression coil spring 60 is compressed during the fastening process of the fixing member 80, and is further compressed under stress in the case 20 that does not exceed the elastic limit. As illustrated in FIGS. 2 and 3, when the fixing member 80 is fastened, a pitch between coils of the compression coil spring 60 becomes sufficiently small, such that adjacent wire portions come into close contact with each other.

### Operation of electrical connection box 10

The movable member 40 is inserted into the guide hole 21 from above. In the process of inserting the movable member 40, the radially outer end of the flange portion 42 interferes with the distal end of the protrusion 26, thereby causing the elastic lock portion 25 to be elastically deformed radially outward. When the flange portion 42 rides over the protrusion 26, the elastic lock portion 25 elastically returns, and as illustrated in FIG. 1, the distal end of the protrusion 26 is disposed so as to cover the radially outer end of the flange portion 42 from above. The movable member 40 is restrained from coming out upward from the guide hole 21 by the protrusion 26. The movable member 40 is supported inside the guide hole 21 by the compression coil spring 60 so as to be movable in a reciprocating manner in the vertical direction.

Before fastening the fixing member 80, specifically, before the nut 82 is screwed onto the stud bolt 81, in the guide hole 21, the lower end of the cylindrical portion 41 of the movable member 40 can be disposed above and away from the fastening portion 94 of the mounting surface 91, and the lower end of the inner peripheral portion 32 of the support portion 30 can also be disposed above and away from the fastening portion 94 of the mounting surface 91. Here, a separation distance between the lower end of the cylindrical portion 41 and the fastening portion 94 is larger than a separation distance between the lower end of the inner peripheral portion 32 and the fastening portion 94.

From the above state, the nut 82 is screwed onto an upper end portion of the shaft portion 83 of the stud bolt 81 (the portion protruding upward from the guide hole 21). After the nut 82 comes into contact with the seating surface 43 of the movable member 40, by further screwing of the nut 82, the movable member 40 moves downward which is a direction toward the mounting surface 91 while resisting the biasing force of the compression coil spring 60. At this time, the movement of the cylindrical portion 41 is guided by the inner peripheral portion 32 of the support portion 30. As the movable member 40 moves downward, the compression coil spring 60 is compressed in the vertical direction between the flange portion 42 of the movable member 40 and the annular portion 31 of the support portion 30 as illustrated in FIGS. 2 and 3. At this time, since the annular portion 31 of the support portion 30 is pressed by the compression coil spring 60, the guide peripheral wall portion 22 to which the support portion 30 is fixed may also move so as to approach the mounting surface 91.

When the lower end of the cylindrical portion 41 reaches a position where it comes into contact with the fastening portion 94 of the mounting surface 91, further screwing of the nut 82 is restrained, and movement of the movable member 40 is also stopped. When the lower end of the respective cylindrical portions 41 come into contact with the corresponding fastening portions 94 of the mounting surface 91, the fastening work of the fixing members 80 is completed. As a result, the electrical connection box 10 is fixed to the mounting surface 91. In the first embodiment, screwing of the nut 82 is restrained at a position where the lower end of the cylindrical portion 41 comes into contact with the fastening portion 94 of the mounting surface 91, and movement of the movable member 40 is also automatically stopped. Therefore, torque management of the fixing member 80 is not required, and workability is excellent.

In the above, until fastening of the fixing member 80 is completed, the movable member 40 can move according to a screwing amount of the nut 82 (a screwing amount from the state in which the nut 82 is in contact with the seating surface 43). On the other hand, the support portion 30 (the guide peripheral wall portion 22) can move by an amount obtained by subtracting a compression amount of the compression coil spring 60 from the screwing amount of the nut 82.

When fixing the electrical connection box 10 to the mounting surface 91, due to the influence of tolerance variations or the like, the fixing member 80 may be forcibly fastened in a state where the height positions of the respective fastening portions 94 of the mounting surface 91 are displaced from predetermined positions. During such fastening of the fixing member 80, as illustrated in FIG. 3, a large gap G is formed between the fastening portion 94 having a large positional deviation and the support portion 30, whereas as illustrated in FIG. 2, a gap smaller than the gap G or a zero-gap state is formed between the fastening portion 94 having a small positional deviation (including the fastening portion 94 at the predetermined position) and the support portion 30. That is, the compression coil spring 60 is compressed in the vertical direction, whereby the amount of positional deviation between the support portions 30 corresponding to the respective fastening portions 94 is suppressed to be smaller than the amount of positional deviation between the respective fastening portions 94. Since the amount of positional deviation between the support portions 30 is suppressed to be small, it is possible to prevent stress exceeding the elastic limit from being generated in the case 20 to which each support portion 30 is fixed. As a result, even when the case 20 contains glass fiber, it is possible to prevent the case from being damaged beyond the elastic limit.

As described above, the electrical connection box 10 of the first embodiment includes the case 20 having the guide hole 21, the movable member 40 disposed inside the guide hole 21, and the compression coil spring 60 as a biasing member disposed between the case 20 and the movable member 40. The case 20 is fixed to the mounting surface 91 by fastening the fixing member 80. The movable member 40 is movable in a moving direction (downward) toward the mounting surface 91 while resisting the biasing force of the compression coil spring 60 during the fastening process of the fixing member 80. The distal end (lower end) of the movable member 40 in the moving direction is in contact with the mounting surface 91 when the fixing member 80 is fastened.

The distal end (lower end) of the movable member 40 in the moving direction comes into contact with the mounting surface 91, and thus a state in which the case 20 is fixed to the mounting surface 91 by fastening the fixing member 80 can be reliably formed. When the case 20 has a plurality of guide holes 21 and the movable member 40 is disposed inside each guide hole 21, even if the height positions of the fastening portions 94 of the mounting surface 91 corresponding to the respective fixing members 80 are displaced from predetermined positions due to tolerance variations or the like, such positional deviation is absorbed by the compression coil spring 60 disposed between the case 20 and the movable member 40. As a result, it is possible to suppress damage to the case 20 during fastening of the fixing member 80. In particular, the compression coil spring 60 as a biasing member can bias the movable member 40 with an appropriate biasing force according to the magnitude of the movement stroke of the movable member 40.

In addition, in the first embodiment, the movable member 40 includes the cylindrical portion 41 extending in the vertical direction and the flange portion 42 projecting outward from the cylindrical portion 41 in the radial direction of the cylindrical portion 41. The support portion 30 is provided inside the guide hole 21 at a position away downward from the flange portion 42. The support portion 30 is provided integrally with the case 20 or fixed to the case 20. The compression coil spring 60 is compressively disposed between the support portion 30 and the flange portion 42. The shaft portion 83 of the fixing member 80 is disposed inside the cylindrical portion 41. According to this configuration, the movable member 40 and the compression coil spring 60 can be disposed in the case 20 together with the fixing member 80 with high space efficiency.

Further, in the first embodiment, the case 20 has the elastic lock portion 25 along the inner surface of the guide hole 21. The elastic lock portion 25 has the protrusion 26 protruding into the guide hole 21. The flange portion 42 is disposed between the protrusion 26 and the compression coil spring 60 in the vertical direction. According to this configuration, the movable member 40 can be inserted into the guide hole 21 after the elastic lock portion 25 is elastically deformed. The movable member 40 inserted into the guide hole 21 is prevented from coming out of the guide hole 21 by contacting the protrusion 26. Accordingly, the movable member 40 can be prevented from coming out with a relatively simple structure.

### Another embodiment of the present disclosure

It should be considered that the embodiment disclosed herein is an example in all respects and is not restrictive.

In the first embodiment described above, the case is made of a synthetic resin containing glass fibers. In contrast, according to another embodiment, the case may be made of a synthetic resin containing no glass fibers.

In the first embodiment described above, the biasing member is constituted by a compression coil spring. In contrast, according to another embodiment, the biasing member is not limited to the compression coil spring, and may be, for example, an elastic member having a cushioning properties disposed between the case and the movable member, or may be a torsion coil spring, a leaf spring, or the like.

In the first embodiment described above, the guide hole is provided in the upper case, and the movable member and the biasing member are assembled to the upper case. In contrast, according to another embodiment, the guide hole may be provided in the lower case, and the movable member and the biasing member may be assembled to the lower case. In addition, when the case is a single case that is not separable into the lower case and the upper case, for example, a guide hole may be provided in the mounting portion projecting laterally from the case, and the movable member and the biasing member may be assembled to the mounting portion.

In the first embodiment described above, the support portion is configured as an embedded collar insert-molded into and fixed to the case. In contrast, according to another embodiment, the support portion may be provided integrally with the case as a part of the case.

In the first embodiment described above, the fixing member including the stud bolt and the nut is used for attaching the electrical connection box to the mounting surface. In contrast, according to another embodiment, it is also possible to use a general bolt and a nut for attaching the electrical connection box to the mounting surface. When a general bolt is used, it is also possible to adopt a configuration in which a head of the bolt is brought into contact with the seating surface of the movable member, and the bolt is fastened.

In the first embodiment described above, the object to which the electrical connection box is attached (the object to which the electrical connection box is fixed) is a battery pack. In contrast, according to another embodiment, the object to which the electrical connection box is attached is not limited to a battery pack, and may be, for example, a vehicle body.

What is claimed is:

1. An electrical connection box comprising:
a case having a guide hole;
a movable member disposed inside the guide hole; and
a biasing member disposed between the case and the movable member,
wherein the case is fixed to a mounting surface by fastening a fixing member,
wherein the movable member is movable in a moving direction toward the mounting surface while resisting a biasing force of the biasing member during a fastening process of the fixing member, and
wherein a distal end of the movable member in the moving direction is in contact with the mounting surface when the fixing member is fastened.

2. The electrical connection box according to claim 1, wherein the biasing member is a compression coil spring.

3. The electrical connection box according to claim 2,
wherein the movable member includes a cylindrical portion extending in the moving direction and a flange portion projecting outward from the cylindrical portion in a radial direction thereof,
wherein a support portion is provided inside the guide hole at a position away from the flange portion in the moving direction,
wherein the support portion is provided integrally with the case or fixed to the case,
wherein the compression coil spring is compressibly disposed between the support portion and the flange portion, and
wherein a shaft portion of the fixing member is disposed inside the cylindrical portion.

4. The electrical connection box according to claim 3,
wherein the case includes an elastic lock portion along an inner surface of the guide hole,
wherein the elastic lock portion has a protrusion protruding into the guide hole, and
wherein the flange portion is disposed between the protrusion and the compression coil spring in the moving direction.
